(19) United States
(12) Patent Application Publication
(10) Pub. No.: US 2012/0075454 A1
(43) Pub. Date: Mar. 29, 2012

(54) ELECTRONIC MAGNIFIER

(75) Inventor: Eiji SUGIYAMA, Aichi (JP)

(73) Assignee: Elmo Co., Ltd., Nagoya-shi (JP)

(21) Appl. No.: 13/205,713

(22) Filed: Aug. 9, 2011

(30) Foreign Application Priority Data
Sep. 29, 2010 (JP) 2010-218016

(51) Int. Cl. H04N 7/18

(52) U.S. Cl. 348/79; 348/E07.085

(57) ABSTRACT

An electronic magnifier includes a stage on which an object to be read is placed, an imaging unit which is disposed above the stage to image the object, a liquid crystal display (LCD) monitor which is mounted via a pivoting member to the imaging unit so as to be pivotable, wherein the LCD monitor is configured to be accommodated in a space defined between the imaging unit and the stage.

### CROSS-REFERENCE TO RELATED APPLICATIONS

This application is based upon and claims the benefit of priority from Japanese Patent Application No. 2010-218016 filed Sep. 29, 2010, the entire contents of which are incorporated herein by reference.

### BACKGROUND

1. Field

The present disclosure relates to an electronic magnifier which magnifies and displays an object to be read.

2. Related Art

Use of liquid crystal display (LCD) monitors in electronic magnifiers has been increased with progress in diffusion of the LCDs. However, an LCD monitor extends off a body of the electronic magnifier to a large extent. Accordingly, the LCD monitor is impeditive during non-use of the electronic magnifier or when the electronic magnifier is housed in a casing or the like. As a result, a more compact electronic magnifier has been desired.

Furthermore, since an increased external size of the product is disadvantageous in transportation, the LCD monitor, monitor arms or a magnifier body are separately packed and shipped. As a result, users most of whom are visually-impaired need to carryout works with higher degrees of difficulty such as mounting of the monitor, electrical wiring and the like.

### SUMMARY

Therefore, an object of the disclosure is to provide a electronic magnifier which is compacted and provided with an LCD monitor, which can be shipped with the LCD monitor being mounted on the magnifier body, which does not necessitate doing works with higher degrees of difficulty such as mounting of the monitor, electrical wiring and the like and which can simplify the packing and reduce transport costs.

The disclosure provides an electronic magnifier comprising a stage on which an object to be read is placed, an imaging unit which is disposed above the stage to image the object placed on the stage, a liquid crystal display (LCD) monitor which is mounted via a pivoting member to the imaging unit so as to be pivotable, wherein the LCD monitor is configured to be accommodated in a space defined between the imaging unit and the stage.

According to the above-described construction, the electronic magnifier provided with the LCD monitor can be rendered more compacted and can be shipped with the LCD monitor being mounted on the magnifier body. Furthermore, the electronic magnifier does not require the user to do works with higher degrees of difficulty such as mounting of the monitor, electrical wiring and the like and can simplify the packing and reduce transport costs.

### BRIEF DESCRIPTION OF THE DRAWINGS

FIG. 1 is a perspective view of an electronic magnifier according to one embodiment;

FIG. 2 is also a perspective view of the electronic magnifier, explaining the operation of the electronic magnifier;

FIG. 3 is a partial perspective view of a pivoting member of the electronic magnifier, explaining the inner structure of the pivoting member shown in FIG. 1; and

FIG. 4 is also a partial perspective view of the pivoting member of the electronic magnifier shown in FIG. 1, explaining the operation of the pivoting member.

### DETAILED DESCRIPTION

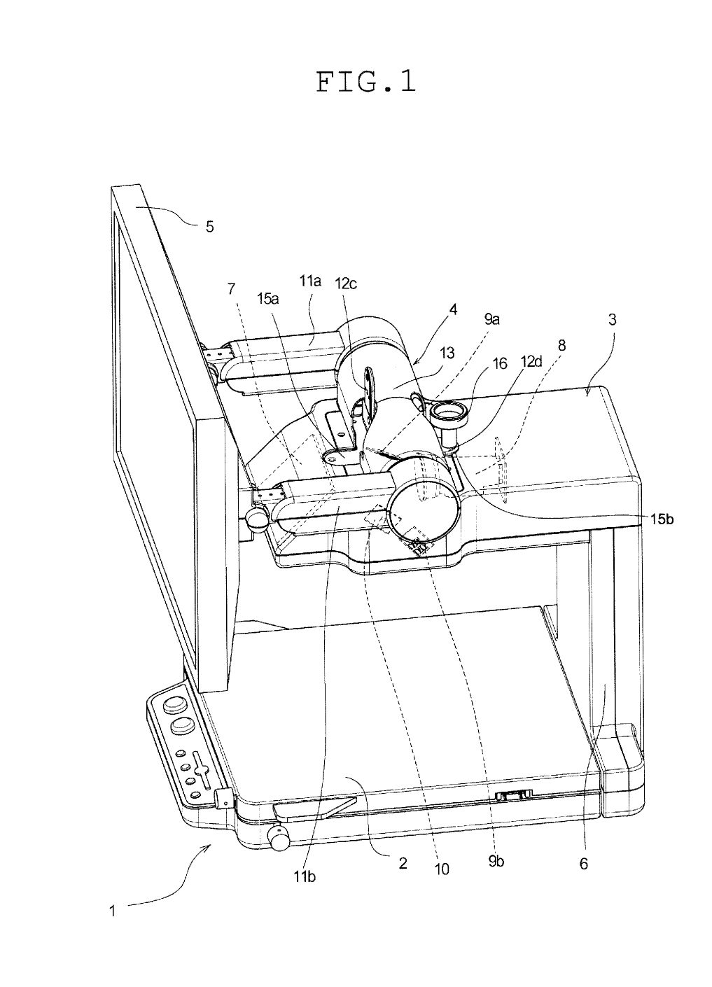

One embodiment will be described with reference to the accompanying drawings. Referring to FIG. 1, an electronic magnifier 1 according to the embodiment is shown in a perspective view. The electronic magnifier 1 includes a stage 2 on which an object to be read, such as a book, is placed, an imaging unit 3 which is disposed above the stage 2 to image the object, a liquid crystal display (LCD) monitor 5 which is mounted via a pivoting member 4 to the imaging unit 3. The LCD monitor 5 is configured to be accommodated in a space defined between the stage 2 and the imaging unit 3 as the result of pivoting of the pivoting member 4. The aforementioned components of the electronic magnifier will be described in detail in the following.

The stage 2 has an upper surface on which an object to be read is placed. The stage 2 is provided with a cross slide mechanism (not shown) so as to be movable in a front-rear direction and in a right-left direction.

The imaging unit 3 images the object placed on the stage 2 to display a magnified image of the object on the LCD monitor 5. A support arm 6 stands on a rear of the stage 2 and has an upper end from which the imaging unit 3 extends horizontally toward the front. The imaging unit 3 is generally formed into the shape of a box extending horizontally from an upper end of the support arm 6.

In the imaging unit 3 are incorporated a mirror 7 tilted at an angle of 45° relative to the horizontal direction, a lens unit 8 which is opposed to the mirror 7 in a horizontal position, two lamps 9a and 9b, a pointer 10 and a control (not shown). The mirror 7 has an imaging hole (not shown) formed in a lower portion thereof. The lens unit 8 is configured to image the object incident on the mirror 7 through the imaging hole.

The lamps 9a and 9b are mounted on lower surfaces of right and left sides of the imaging unit 3 respectively, thereby illuminating the upper surface of the stage 2. The pointer 10 is provided for illuminating substantially the center of a shooting range of the lens unit 8 on the stage 2. The pointer 10 comprises LED illumination lamps.

The control is configured to control various image processing including processing and output of image signals obtained by the lens unit 8 on the basis of a predetermined switch input, on-off control of the lamps 9a and 9b or pointer 10. The control is provided with a voice recorder (not shown) for voice-explaining a usage of the magnifier. The LCD monitor 5 is provided for magnifying an image taken by the lens unit 8 and displaying the magnified image.

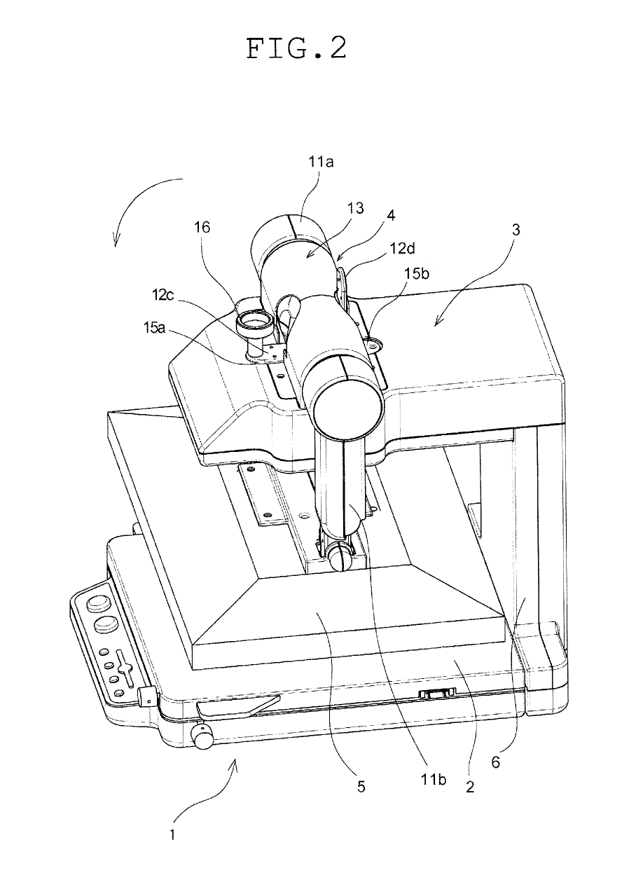

The LCD monitor 5 is mounted on a pivoting member 4 further mounted on the imaging unit 3 so as to be pivotable. More specifically, the LCD monitor 5 is configured to be pivotable by 90° counter-clockwise from a position as shown in FIG. 1 (a front forward position of the imaging unit 3) to a position as shown in FIG. 2 (a lower position of the imaging unit 3), whereupon the LCD monitor 5 can be accommodated in a space defined between the stage 2 and the imaging unit 3, as shown in FIG. 2. Consequently, the electronic magnifier 1 provided with the LCD monitor 5 can be rendered more compact and can be shipped with the LCD monitor 5 being mounted on the magnifier body. A visually-impaired user need not do works with higher degrees of difficulty such as the mounting of the monitor, electrical wiring or the like, and the electronic magnifier 1 provided with the LCD monitor 5 can simplify the packing and reduce transport costs.

On the other hand, when the electronic magnifier 1 is to be used, the LCD monitor 5 is caused to pivot clockwise 90° from the position as shown in FIG. 2 (the lower position of the imaging unit 3) to the position as shown in FIG. 1 (the front forward position of the imaging unit 3), whereby the object on the vertical screen of the LCD monitor 5 can be read. More specifically, when placed on the upper surface of the stage 2 according to the illumination of the pointer 10, an object to be read is reflected on the mirror 7 to be imaged by the lens unit 8. An image processing section (not shown) of the lens unit 8 executes a reversal processing for the taken image, thereby obtaining an erected image, which is displayed on the screen of the LCD monitor 5 in a magnified state. Thus, the user can read the magnified object.

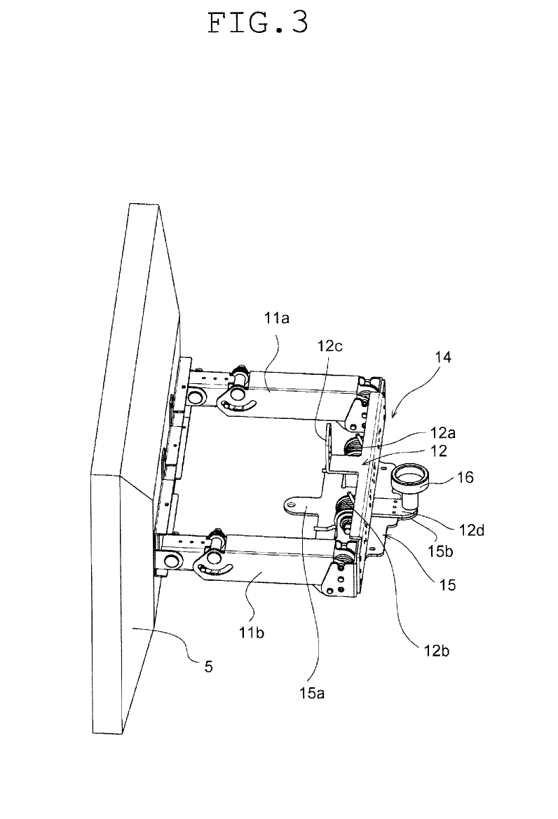

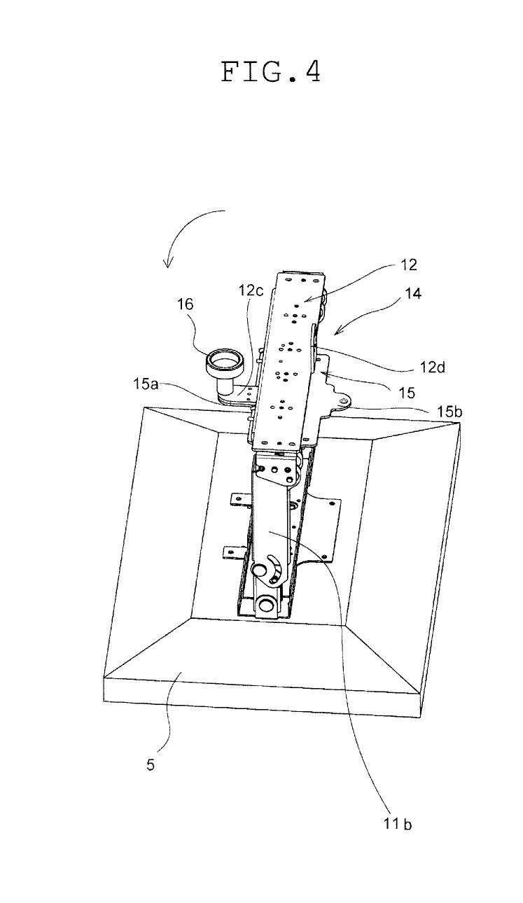

The pivoting member 4 on which the LCD monitor 5 is supported is further mounted to the imaging unit 3 so that the pivoting member 4 is pivotabie. The pivoting member 4 is caused to pivot so that the LCD monitor 5 is accommodated in the space defined between the stage 2 and the imaging unit 3. The pivoting member 4 includes a pair of monitor arms 11a and 11b which are mounted on both sides of the imaging unit 3 respectively and have distal ends to which the LCD monitor 5 is fixed. The pivoting member 4 also includes a cooperating member 12 provided between proximal ends of the monitor arms 11a and 11b as shown in FIGS. 3 and 4. The cooperating member 12 is caused to pivot with a cover 13 in conjunction with a pivotal movement of the monitor arms 11a and 11b. The cooperating member 12 is urged by elastic member 12a and 12b.

More specifically, the cooperating member 12 is urged so that when caused to pivot from a horizontal position thereby to be lowered, the cooperating member 12 applies a restoring force to the monitor arms 11a and 11b, whereby the monitor arms 11a and 11b are moved toward the horizontal position. Consequently, the LCD monitor 5 accommodated in the space between the stage 2 and the imaging unit 3 is lifted slightly upward in use, whereupon the load on the user can be reduced.

Furthermore, the electronic magnifier 1 is provided with a locking mechanism 14 which retains the LCD monitor 5 in an accommodated state between the stage 2 and the imaging unit 3. The locking mechanism 14 includes a pair of pivoting pieces 12c and 12d which are formed integrally with the cooperating member 12 and extend in respective directions perpendicular to each other, a pair of locking pieces 15a and 15b which are disposed below the cooperating member 12 so as to extend in front of and in the rear of a fixing plate 15 to be fixed to an upper surface of the imaging unit 3, respectively and a locking member 16, as shown in FIG. 3.

In a state where the screen of the LCD monitor 5 is directed to the front as shown in FIG. 1, the pivoting piece 12d is in threading engagement with the locking member 16 thereby to be fixed while overlapping the upper surface of the locking piece 15b, as shown in FIG. 3. As a result, the LCD monitor 5 is held in a frontwardly directed state.

On the other hand, in a state where the LCD monitor 5 is directed downward as shown in FIG. 2, the pivoting piece 12c is in threading engagement with the locking member 16 thereby to be fixed while overlapping the upper surface of the locking piece 15a, as shown in FIG. 4, whereupon the LCD monitor 5 is held in a downwardly directed state. Consequently, the LCD monitor 5 is configured to be reliably retained in the accommodated state between the stage 2 and the imaging unit 3 against an upward restoring force (the pivoting force) applied to the cooperating member 12.

According to the foregoing embodiment, the electronic magnifier 1 with the LCD monitor 5 can be rendered more compact since the LCD monitor 5 is allowed to be accommodated in the space defined between the stage 2 and the imaging unit 3. Accordingly, the electronic magnifier 1 can be shipped with the LCD monitor 5 being mounted thereon and therefore, a visually-impaired user need not carry out works with higher degrees of difficulty such as mounting of the monitor, electrical wiring and the like. This can simplify the packing and reduce transport costs.

The pivoting member 4 is mounted on the upper portion of the imaging unit 3 in the foregoing embodiment. However, the pivoting member 4 should not be limited to the above-described construction. The monitor arms may be pivotally mounted on the respective sides of the imaging unit, instead. Furthermore, the pivoting member 4 has the paired monitor arms 11a and 11b mounted on both sides of the imaging unit 3 respectively in the foregoing embodiment. However, the LCD monitor may be pivotally mounted on a single monitor arm, instead.

The foregoing embodiment employs the locking mechanism in which the pivoting piece 12d is threadingly engaged with the locking member 16 while being placed on the upper surface of the locking piece 15b. The locking mechanism should not be limited to the above-described construction. The pivoting piece 12d may be hooked on the locking piece 15b with a single touch thereof using hooking means, for example.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. An electronic magnifier comprising:
a stage on which an object to be read is placed;
an imaging unit which is disposed above the stage to image the object placed on the stage;
a liquid crystal display (LCD) monitor which is mounted via a pivoting member to the imaging unit so as to be pivotable,
wherein the LCD monitor is configured to be accommodated in a space defined between the imaging unit and the stage.

2. The magnifier according to claim 1, further comprising a locking mechanism which retains the LCD monitor in a retained state in the space between the imaging unit and the stage.

3. The magnifier according to claim 1, wherein the pivoting member has a pair of monitor arms which are provided on both sides of the imaging unit respectively and have respective distal ends to which the LCD monitor is fixed and a cooperating member provided between proximal ends of the respective monitor arms, the cooperating member being urged by an elastic member so that when caused to pivot from a horizontal position thereby to be lowered, the cooperating member applies a restoring force to the monitor arms, whereby the monitor arms are moved toward the horizontal position.

4. The magnifier according to claim 2, wherein the pivoting member has a pair of monitor arms which are provided on both sides of the imaging unit respectively and have respective distal ends to which the LCD monitor is fixed and a cooperating member provided between proximal ends of the respective monitor arms, the cooperating member being urged by an elastic member so that when caused to pivot from a horizontal position thereby to be lowered, the cooperating member applies a restoring force to the monitor arms, whereby the monitor arms are moved toward the horizontal position.
